(19) United States
(12) Patent Application Publication
(10) Pub. No.: US 2014/0152891 A1
(43) Pub. Date: Jun. 5, 2014

(54) Method and Apparatus for Reducing Digital Video Image Data

(71) Applicant: Silicon Image, Inc., Sunnyvale, CA (US)

(72) Inventors: Jeffrey M. Gilbert, Cupertino, CA (US); Stephen Bennett, San Francisco, CA (US); Dmitry Cherniavsky, San Jose, CA (US); Ting-Kuo Lo, San Jose, CA (US); Nishit Kumar, San Jose, CA (US)

(73) Assignee: Silicon Image, Inc., Sunnyvale, CA (US)

(21) Appl. No.: 13/738,768

(22) Filed: Jan. 10, 2013

Related U.S. Application Data
(60) Provisional application No. 61/733,817, filed on Dec. 5, 2012.

(51) Int. Cl. H04N 7/01

(52) U.S. Cl. CPC H04N 7/01
USPC 348/441

(57) ABSTRACT

A method and apparatus is disclosed herein for reducing digital video image data. In one embodiment, the method comprises comparing a signature for one or more regions of a current frame of the image data to a signature of a corresponding region of one or more previous frames; and for a region of the one or more regions, sending the region to the data sink if comparing the signature results in determining that the signature of the region does not match a signature of a corresponding region of a previous frame available at the data sink.

### PRIORITY

The present patent application claims priority to and incorporates by reference the corresponding provisional patent application Ser. No. 61/733,817, titled, “Method and Apparatus for Reducing Digital Video Image Data” filed on Dec. 5, 2012.

### FIELD OF THE INVENTION

Embodiments of the present invention relate to the field of transfer of image data; more particularly, embodiments of the present invention relate to reducing the amount of digital image data being transferred between a data source and a data sink based on whether the image data has changed based on its signature.

### BACKGROUND OF THE INVENTION

Today, video data is frequently transferred between two devices. These devices are often referred to as a data source and a data sink. The video data is transferred as a series of video frames comprising image data. The image or parts of the image in video frame often remains static across neighboring or consecutive frames. This property of the video is used by video codecs to compress the video data bit stream. Existing inter-frame compression methods such as H.264 require that the previous frame is stored in the codec so they can be compared against incoming frame data on a pixel-by-pixel basis to produce a difference between the two frames. The difference is then compressed and transferred as opposed to transferring the entire incoming frame.

In order to perform frame comparisons, a frame buffer on the source side is needed. For the high video resolutions, the requirement of a frame buffer results in large video memory requirements, thereby increasing the cost of the source device and increased power consumption to access the memory and compare the video data. Source devices that implement a video transmission function for mobile devices have to be cost-effective and consume very small amount of power. Therefore, mobile devices have difficulty being cost-effective when needing a frame buffer and having to do pixel-by-pixel compare operations.

### SUMMARY OF THE INVENTION

A method and apparatus is disclosed herein for reducing digital video image data. In one embodiment, the method comprises comparing a signature for one or more regions of a current frame of the image data to a signature of a corresponding region of one or more previous frames; and for a region of the one or more regions, sending the region to the data sink if comparing the signature results in determining that the signature of the region does not match a signature of a corresponding region of a previous frame available at the data sink.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a data source that sends image data (e.g., video frames) to a data sink.

FIG. 2 is a dataflow diagram of one embodiment of the process for controlling an amount of digital image data being transmitted between a data source and a data sink.

FIG. 3 illustrates portions of one embodiment of a data source and one embodiment of a data sink.

FIG. 4A is a data flow diagram of one embodiment of the data reduction process performed by a data source.

FIG. 4B is a data flow diagram of one embodiment of the process performed by a data sink to complement the data reduction process performed by the data source.

FIG. 5 is a block diagram of one embodiment of a computer system.

### DETAILED DESCRIPTION OF THE PRESENT INVENTION

A method and apparatus for use in transferring image data, such as frames of video data between a data source and a data sink are described. In one embodiment, each of the frames of video are divided into one or more regions and the data source determines whether each region is to be transferred to the data sink. The data source makes the determination based on whether each region has undergone a change between the current frame and the previous frame. If a region has changed, then the data source sends the region to the data sink. If the region hasn't changed, then the data source does not send the region to the data sink. For purposes of comparing a region in the current frame with its corresponding region in the previous frame, instead of performing a pixel-by-pixel comparison between the regions, the data source only compares signatures (e.g., checksums) of the regions being compared to determine if a region has changed. Since only signatures are compared, the data source does not need to store the complete frame or region; the data source needs only to store a signature of all pixels in a region, which is typically much smaller than the data for the region itself. For subsequent frames, the stored signature of each region is compared against the signature of the corresponding region and if they match each other, the data source may omit the video data for that region from the video stream being sent to the data sink. When the resulting video stream needs to be displayed by data sink receiving the stream, the omitted regions of video data are replaced by the video data stored from the previous frame in the video receiver frame buffer. Thus, no frame buffer is required on the data source (or the transmitter of the video data).

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

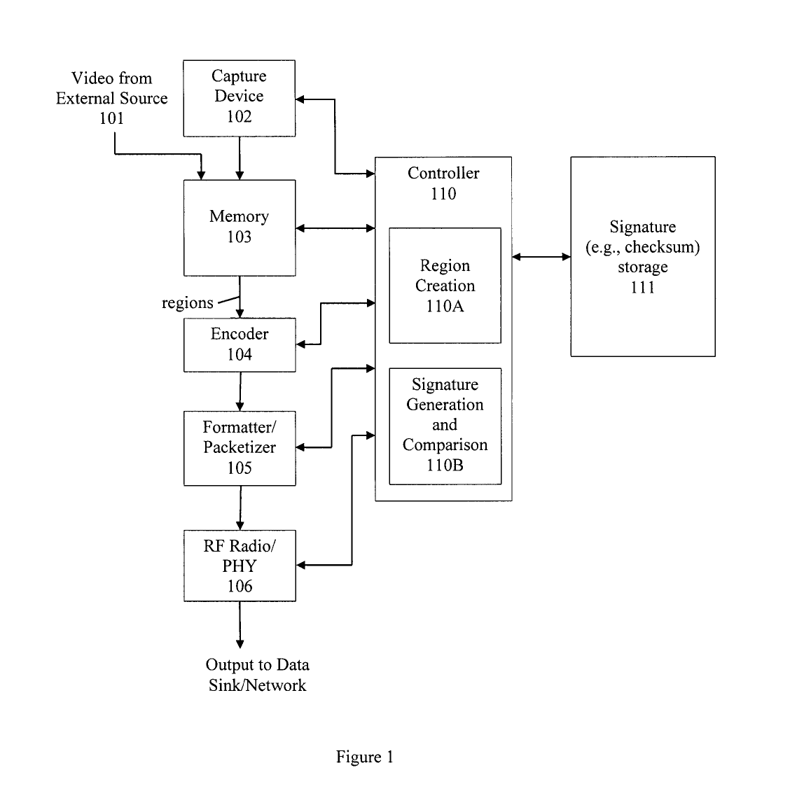

An apparatus and method for reduction of video data are disclosed. FIG. 1 is a block diagram of one embodiment of a data source that sends image data (e.g., video frames) to a data sink. The data may be sent via a wired or wireless connection and may or may not involve the use of a network in between the data source and data sink.

Referring to FIG. 1, data source 100 receives video frames 101 (or other image data) from an external source. In one embodiment, data source 100 includes a data capture device 102 (e.g., a camera) that is capable of acquiring video or other image data to be provided by data source 100 to a data sink.

Memory 103 buffers the video frames as they are received. In one embodiment, each frame of video is stored as multiple regions. In one embodiment, controller 110 divides each frame into a number of regions using region creation module 110A. In one embodiment, the regions generated by region creation module 110A are stored back into memory. In another embodiment, the regions generated by region creation module 110A are sent to signature generation and comparison module 110B. Note that region creation module 110A may not be part of controller 110 (e.g., processor). In one such a case, in one embodiment, region creation module 110A is controlled by controller 110. In a case where the modules are software, controller 110 may execute or control execution of the software.

Signature generation and comparison module 110B of controller 100 generates a signature (e.g., checksum, hash, etc.) for each region of the frame stored in memory 103. If the frame is the first frame in a video frame sequence, signature generation and comparison module 110B stores the signature(s) in signature storage 111. If the frame is not the first frame in the video frame sequence, then signature generation and comparison module 110B compares the signature for a region to a signature stored in signature storage 111, that is for the same region in the earlier frame. If the signatures do not match, indicating that the region of the current frame is different than its corresponding region in a previous frame (e.g., region of the current frame has changed from what it was in that previous frame), then signature generation and comparison module 110B provides an indication (e.g., a signal) to controller 110. In response thereto, controller 110 signals memory to output the region for transmission to the data sink. In case the signatures do not match, signature generation and comparison module 110B also stores the newly generated signature into signature storage 111 for use in comparison with the signature of the same corresponding region in the next and potentially subsequent video frames.

If the signatures do match, indicating that the region of the current frame is same as its corresponding region in the previous frame (e.g., region of the current frame has not changed from what it was in the previous frame), then signature generation and comparison module 110B provides an indication (e.g., a signal) to controller 110 that the region hasn't changed. In response thereto, controller 110 does not signal the memory to output the region for transmission to the data sink, effectively suppressing its transmission to the data sink. In some cases, transmission still occurs even if the signature matches. For example, if the “reference” region is known not to have been received by the sink, the region is sent.

Note that signature generation and comparison module 110B may not be part of controller 110. In such a case, signature generation and comparison module 110B may still be controlled by controller 110.

In one embodiment, regions of a frame that are sent to the data sink are encoded using encoder 104, formatted and/or packetized by formatter/packetizer 105, and then transmitted to data sink and/or a network (for delivery to the data sink) using a radio-frequency (RF) radio and/or PHY 106 under control of controller 110. Note that in one embodiment, encoding and formatting/packetization are not performed and the image data in the regions is transmitted directly to a data sink.

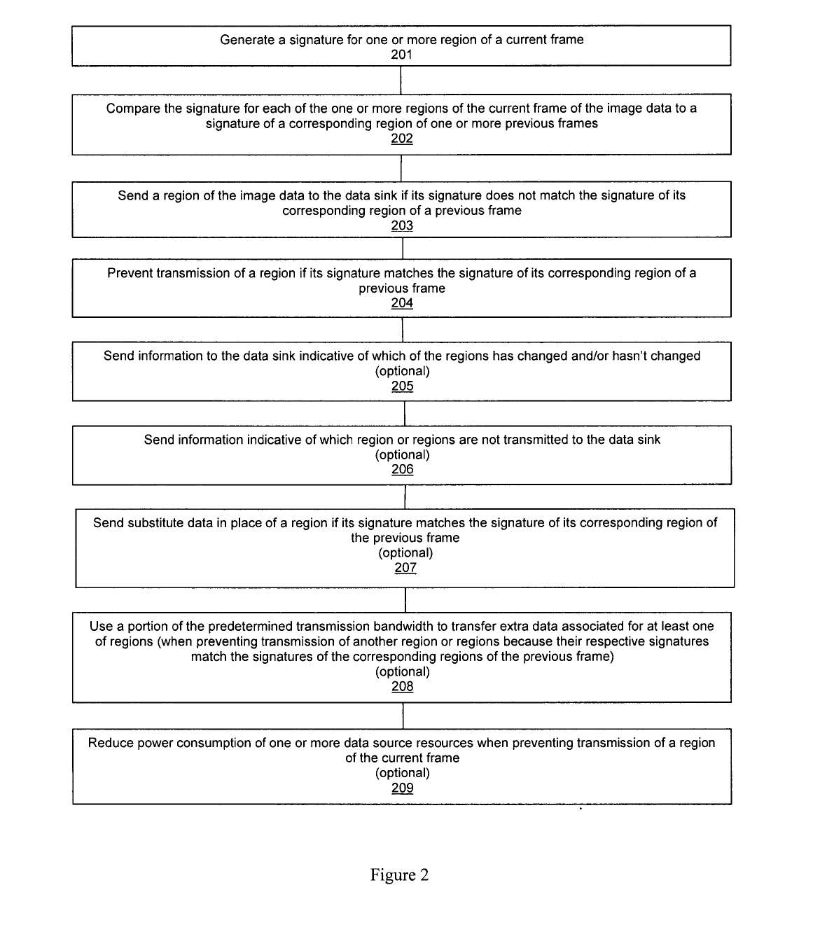

FIG. 2 is a dataflow diagram of one embodiment of the process for controlling an amount of digital image data being transmitted between a data source and a data sink. The process is performed by processing logic that may comprise hardware (circuitry, dedicated logic, etc.), software (such as is run on a general purpose computer system or a dedicated machine), or a combination of both. In one embodiment, the process is performed by the data source of FIG. 1.

Referring to FIG. 2, processing logic generates a signature for one or more regions of a current frame (processing block 201). In one embodiment, the signature is the output of a hash function applied to the image data in the region. In one embodiment, the signature comprises a checksum. In one embodiment, the checksum is a cyclic redundancy check (CRC) (e.g., a 32-bit CRC).

In one embodiment, each region (or at least one of the regions) is a horizontal slice of a frame comprising multiple consecutive pixel lines (e.g., 2 lines, 4 lines, 8 lines, 16 lines, etc.) of a frame. In one embodiment, each region (or at least one of the regions) is a rectangle (e.g., an 8×8 square of pixels). In one embodiment, each region constitutes an entire frame. In one embodiment, each region comprises multiple components and the signature is based on less than all of the multiple components or there are multiple signatures, one per component. In one embodiment, the components include luma and/or chroma components. In such a case, the signature may be based on only the luma component or only the chroma components. In another embodiment, the components include color components (e.g., RGB components, etc.). In such a case, the signature may be based on only one color component or multiple color components, but not all of them. In another embodiment, two or more regions may be aggregated and one signature generated (and compared) for the aggregated regions.

In one embodiment, processing logic generates a signature for a region without using all data of the one region. For example, in one embodiment, the signature for one region is created without using the least significant bits.

Next, processing logic compares the signature for each region of the current frame of the image data to a signature of a corresponding region of one or more previous frames (processing block 202). In one embodiment, processing logic compares the signatures of only a subset of all regions in the frame. In one embodiment, the regions include a region of the left eye frame and a region of a right eye frame, and a signature for the region on the left eye frame is compared with a corresponding region of a previous left eye frame and a signature for the region of the right eye frame is compared with a signature of the corresponding region of a previous right eye frame, in order to determine if a change has occurred. In one embodiment, the regions includes interlaced regions with odd and even regions of the current frame, and processing logic compares a signature for an odd region with a signature of a corresponding odd region in a previous frame and compares a signature for an even region with a signature of a corresponding even region of a previous frame, in order to determine if a change has occurred between the current frame and image data of a previous frame or frames. In one embodiment, pixel data of one region is split into coarse data and fine data, and processing logic compares signatures: a signature associated with the coarse data of a region in a current frame and a signature associated with the fine data of the a region in the current frame with signatures associated with coarse and fine data of a corresponding region of a previous frame to determine whether to prevent transmission of the one region to the data sink.

Processing logic sends a region of the image data to the data sink if its signature does not match the signature of its corresponding region of a previous frame (processing block 203) and prevents transmission of that region if its signature matches the signature of its corresponding region of a previous frame (processing block 204). In one embodiment, preventing transmission of each region only occurs if an acknowledgment had been received from the data sink that the data sink had received a corresponding region of a previous frame.

In one embodiment, preventing transmission of a region is not performed when a location of the region has been designated prior to signature comparison to have its image data sent to the data sink. In such a case, the image data for that region is transmitted to the data sink. This may be used to ensure that the data sink receives data for each region on a periodic basis as a way to avoid repeatedly propagating the use of incorrect data at the data sink.

In one embodiment, the process further comprises processing logic sending information to the data sink indicative of which of the regions has changed and/or hasn't changed (processing block 205). In one embodiment, the process further comprises processing logic sending information indicative of which region or regions are not transmitted to the data sink (processing block 206). In one embodiment, the information indicative of a region not transmitted to the data sink is derived from the gap in the region serial numbers transmitted to the data sink. In another embodiment, the information indicative of a region not transmitted to the data sink comprises a per-region marker.

In one embodiment, the process further comprises processing logic sending substitute data in place of a region if its signature matches the signature of its corresponding region of the previous frame (processing block 207). In one embodiment, the substitute data comprises all black pixel data, all white pixel data, all grey pixel data, or other data that is able to take the place of the omitted or suppressed region yet is capable of being compressed better than the original image data in the region. This may be useful in situations in which some data must be transmitted for the region due to the transfer protocol that is being employed. Thus, if data has to be transferred to represent the region, it is preferred that the data be highly compressible. In one embodiment, the substitute data is less data than original data. In one embodiment, the substitute data is partial pixel data of the region such that the size of the frame buffer on the data sink side could be reduced.

In one embodiment in which the image data source provides the frames of data to the data sink, if signatures match indicating that some of the frame data does not have to be transmitted, then there will be additional available bandwidth to send information. The information could be from the same frame or another frame or frames. In such a case, the process further comprises processing logic using a portion of the transmission bandwidth to transfer extra data associated for at least one of regions (when preventing transmission of another region or regions, because their respective signatures match the signatures of the corresponding regions of the previous frame) (processing block 208). In this case, the extra data is transferred using bandwidth that would have been used to transfer the regions had transmission of those regions not been prevented. In one embodiment, the extra data comprises finer image data associated with one or more regions.

In one embodiment, the process further comprises processing logic reducing power consumption of one or more data source resources when preventing transmission of a region of the current frame (processing block 209). In one embodiment, the data source resource comprises a radio or part thereof (e.g., transmitter). In one embodiment, the data source resource comprises a PHY of the data source. In another embodiment, the data source resource comprises a video encoder. Note that multiple components may be powered down by processing logic at the same time (e.g., the encoder and the PHY or RF radio). Processing logic could reduce power consumption in a number of well-known ways, including, but not limited to, powering down components or putting such components in a sleep or idle state.

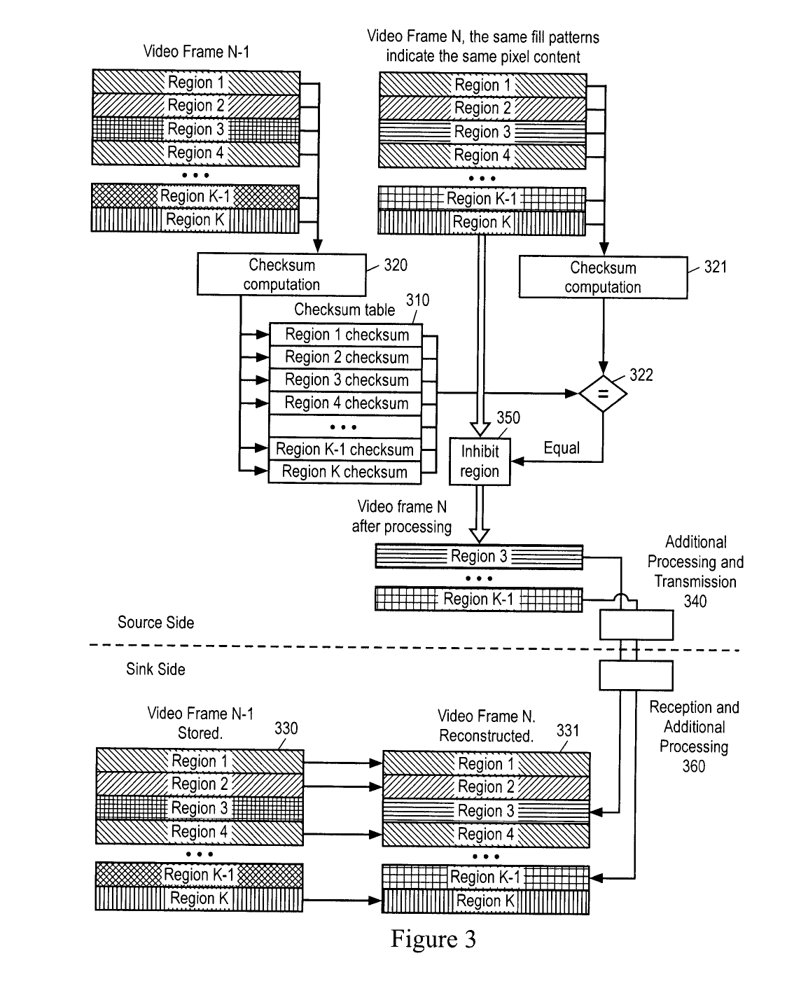

FIG. 3 illustrates portions of one embodiment of a data source and one embodiment of a data sink. Such a portion of the data source may be part of the data source of FIG. 1. Referring to FIG. 3, video frames N−1 and N are shown, where regions having the same fill patterns indicate the same pixel content. As shown, regions 3 and K−1 of video frames N−1 and N are different, while the others are the same. Checksum computation module 320 calculates checksums for each of regions 1 through K of video frame N−1 and stores them in checksum table 310 in memory. When regions of video frame N are received by the video source, checksum computation module 321 calculates checksums for each of regions 1 through K. The checksums for regions 1 through K of video frame N are compared by comparator 322 with the checksum of its corresponding region stored in checksum table 310.

If comparator 322 determines a checksum for a region of video frame N is equal to the checksum of its corresponding region in video frame N−1 (e.g., the checksum for region 2 of video frame N is equal to the checksum for region 2 of video frame N−1), then comparator 322 signals or otherwise provides such an indication to inhibit region logic 350 that prevents the data for that region from being forwarded to the data sink. In this example, regions 1, 2, 4 through K−2, and K are the same and thus inhibit region logic 350 prevents their transfer to the data sink. On the other hand, inhibit region logic 350 determines that the checksums for regions 3 and K−1 do not match the checksums for their corresponding regions in the checksum table 310 and signals that result to inhibit region logic 350. In response to that indication, inhibit region logic 350 enables the image data for regions 3 and K−1 to be output to the data sink.

Note that the image data for the regions being output, regions 3 and K−1 in this example, may undergo additional processing 340 (e.g., encoding, formatting, packetization, etc.), such as is described in FIG. 1, prior to being sent to data sink.

At the data sink, video frame N is reconstructed. In one embodiment, the data sink includes reception capabilities and performs additional processing 360 (de-packetization, decoding, etc.) on data received from the data source prior to frame reconstructions.

In the example, for frame reconstruction, the data sink already has the image data for video frame N−1 stored in a memory 330. In order to create video frame N in memory 331, the data sink receives regions 3 and K−1 from the data source and combines that data with the data for regions 1, 2, 4 through K−2, and K that are already stored in memory 330. In one embodiment, the data sink is able to determine which regions of data it is receiving from the data source based on information stored in the headers of packets it receives. Using this data, the data sink is able to determine what data it needs from memory 330 to complete reconstruction of video frame N.

Also, the data sink stores the regions of reconstructed video frame N so that the image data may be used to reconstruct video frame N+1 and other subsequently received video frames. In one embodiment, storing reconstructed video frame N is no more than storing the image data for those regions that are received corresponding to regions that changed between video frame N−1 and video frame N (e.g., regions 3 and K−1 in the example) into the memory storing the other regions of video frame N−1 that did not change. For example, the image data for regions 3 and K−1 of video frame N replace the image data for regions 3 and K−1 of video frame N−1 stored in memory 330.

Note that in the data source, after comparator 322 determines that the checksums for regions 3 and K−1 of video frame N are not the same as those of the corresponding regions 3 and K−1 of video frame N−1, the checksums for regions 3 and K−1 of video frame N are stored in checksum table 310. Thereafter, when image data for video frame N+1 is to be sent to the data sink, checksums are generated by the data source and compared to the checksums of regions 1, 2, 4 through K−2, and K of video frame N−1 that are still stored in checksum table 310 along with checksums of regions 3 through K−1 of video frame N that have been newly added to checksum table 310. This process continues for the subsequent video frames that are processed such that over time the checksums stored in checksum table 310 may represent the checksums for regions of many different video frames.

Compared to the prior art discussed above, the techniques described herein allow for transferring image data between a data source and a data sink in a cost and power efficient way.

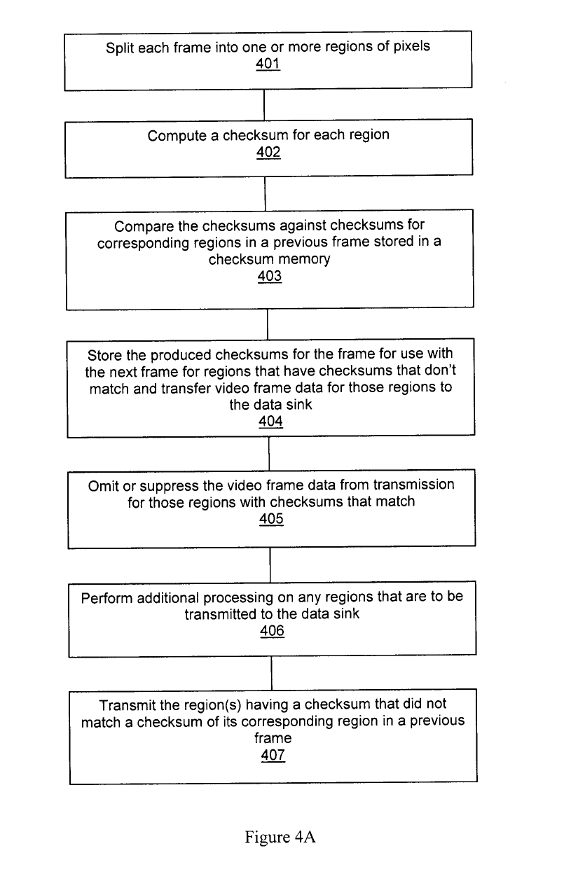

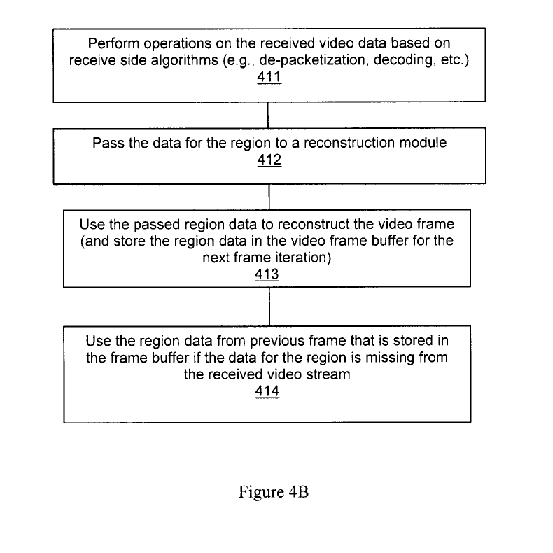

FIG. 4A is a data flow diagram of one embodiment of the data reduction process performed by a data source. The process is performed by processing logic that may comprise hardware (circuitry, dedicated logic, etc.), software (such as is run on a general purpose computer system or a dedicated machine), or a combination of both. In one embodiment, the process is performed by the data source of FIGS. 1 and 3.

Referring to FIG. 4A, the process begins by processing logic splitting each frame into one or more regions of pixels (processing block 401). Next, processing logic computes a checksum for each region (processing block 402). In one embodiment, the checksum is smaller in amount of data than original region. In one embodiment, the checksum algorithm is designed such that any other pixel data resulting in the same checksum is unlikely to be present in the typical video stream.

Thereafter, processing logic compares the checksums against checksums for corresponding regions in a previous frame stored in a checksum memory (processing block 403). Note that the corresponding regions could be parts of multiple different previous frames that have been received by the data sink and stored in the video memory of the data sink.

If the checksums for a region does not match, processing logic stores the produced checksums for the frame for use with the next frame and transfers video frame data for those regions to the data sink (processing block 404).

If the checksums for a region and its corresponding region in a previous frame are equal, processing logic omits or suppresses the video frame data from transmission (processing block 405). In that way, the region from the new frame is omitted from the video data constructed by the data sink.

Thereafter, processing logic performs additional processing on any regions that are to be transmitted to the data sink (processing block 406). Additional processing may include compressing the image data of a region and formatting the image data for transmission.

After additional processing, if any, processing logic transmits the region(s) having a checksum that did not match a checksum of its corresponding region in a previous frame (processing block 407).

Storing and comparing checksums versus original frame data results in significant cost and power savings. Since majority of video data often has significant amount static parts in it, the techniques described herein allow for significant reduction in the transmission bandwidth required for such video.

The data sink performs reconstruction of the video frames using the regions of image data received from the data source. FIG. 4B is a data flow diagram of one embodiment of the data reduction process performed by a data sink. The process is performed by processing logic that may comprise hardware (circuitry, dedicated logic, etc.), software (such as is run on a general purpose computer system or a dedicated machine), or a combination of both. In one embodiment, the reconstruction operations are performed recursively.

Referring to FIG. 4B, the process begins by processing logic performing operations on the received video data based on receive side algorithms (e.g., de-packetization, decoding, etc.) (processing block 411).

Next, processing logic passes the data for the region to a reconstruction module (processing block 412) and uses the passed region data to reconstruct the video frame (and stores the region data in the video frame buffer for the next frame iteration) (processing block 413).

Processing logic uses the region data from previous frame that is stored in the frame buffer if the data for the region is missing from the received video stream (processing block 414). In one embodiment, the absence of the region is detected based on the region number (e.g., by the gap in the region sequence number). In another embodiment, the absence of the region is detected by a marker or by time of arrival depending on video transfer scheme or by other means.

Referring back to FIG. 3, in one embodiment, the inhibit region logic 350 is controlled such that the image data for a region is not suppressed or prevented from being sent to the data sink at times even though its checksum is the same as that of the checksum for its corresponding region stored in the checksum table. This may be done in order to make sure that an error in the image data for each region that is stored in the data sink does not remain stored there and used for reconstructing video frames more than a predetermined number of times. This updating of video data stored at the sink is referred to as a trickle update. In one embodiment, the data for each region is sent uninhibited by inhibit region logic 350 every predetermined number of frames (e.g., in one embodiment, one new region is unconditionally transmitted every frame until all regions are unconditionally sent. The process then repeats.).

In one embodiment, for interlaced video formats, the checksum table in construction method and video frame buffer on reconstruction methods are duplicated per each of odd and even frames.

In one embodiment, when data is transferred over unreliable channel like a wireless channel, the transmit decision logic tracks if the reference region is delivered successfully, for example receipt of by acknowledgement frames, and if it was not delivered, a new region is still sent to avoid trailing errors, regardless of whether its signature (e.g., checksum) matched a signature of its corresponding region of a previous frame.

In one embodiment, data in a region is split into coarse and fine parts and each a separate checksum is computed for each. These separate checksums would be compared against signatures for coarse and fine data parts of a corresponding region of a previous frame. Splitting into coarse and fine parts allows sending video over bandwidth limited channel, and in which there would normally not be enough bandwidth to send such data. In that case only coarse parts are sent first, thereby allowing the coarse image to be reconstructed. If coarse parts of the regions are not changed in the next frame, the logic described here will send the fine parts, thereby allowing complete frame reconstruction.

In another embodiment, the checksums could be computed for individual components of the image data, such as luma components, chroma components, and/or individual color components (e.g., separate checksums for red (R), green (G), and blue (B)).

Note that the techniques described herein are independent of the video frame image content. Therefore, these techniques may be used on compressed images such as Motion JPEG images.

### An Example of a Computer System

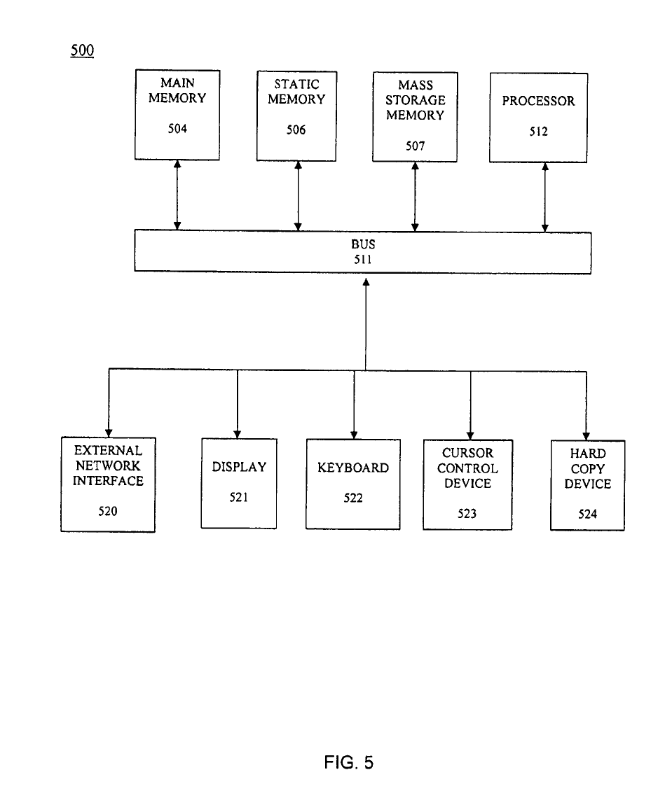

FIG. 5 is a block diagram of an exemplary computer system that may perform one or more of the operations described herein. In one embodiment, the computer system of FIG. 5 may be used to implement either the data source or data sink described herein.

Referring to FIG. 5, computer system 500 may comprise an exemplary client or server computer system. Computer system 500 comprises a communication mechanism or bus 511 for communicating information, and a processor 512 coupled with bus 511 for processing information. Processor 512 includes a microprocessor, but is not limited to a microprocessor, such as, for example, Pentium™, PowerPC™, Alpha™, etc.

System 500 further comprises a random access memory (RAM), or other dynamic storage device 504 (referred to as main memory) coupled to bus 511 for storing information and instructions to be executed by processor 512. Main memory 504 also may be used for storing temporary variables or other intermediate information during execution of instructions by processor 512.

Computer system 500 also comprises a read only memory (ROM) and/or other static storage device 506 coupled to bus 511 for storing static information and instructions for processor 512, and a data storage device 507, such as a magnetic disk or optical disk and its corresponding disk drive. Data storage device 507 is coupled to bus 511 for storing information and instructions.

Computer system 500 may further be coupled to a display device 521, such as a cathode ray tube (CRT) or liquid crystal display (LCD), coupled to bus 511 for displaying information to a computer user. An alphanumeric input device 522, including alphanumeric and other keys, may also be coupled to bus 511 for communicating information and command selections to processor 512. An additional user input device is cursor control 523, such as a mouse, trackball, trackpad, stylus, or cursor direction keys, coupled to bus 511 for communicating direction information and command selections to processor 512, and for controlling cursor movement on display 521.

Another device that may be coupled to bus 511 is a hard copy device 524, which may be used for marking information on a medium such as paper, film, or similar types of media. Another device that may be coupled to bus 511 is a wired/wireless communication capability 525 to communication to a phone or handheld palm device.

Note that any or all of the components of system 500 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method for use by an image data source when providing frames of image data to a data sink, where each of the frames includes one or more regions, the method comprising:
comparing a signature for one or more regions of a current frame of the image data to a signature of a corresponding region of one or more previous frames; and
for a region of the one or more regions, sending the region to the data sink if comparing the signature results in determining that the signature of the region does not match a signature of a corresponding region of a previous frame available at the data sink.

2. The method defined in claim 1 wherein the signature comprises a checksum.

3. The method defined in claim 2 wherein the checksum is a CRC.

4. The method defined in claim 3 wherein the CRC is a 32-bit CRC.

5. The method defined in claim 1 further comprising sending substitute data in place of the region if the signature of the region matches the signature of the corresponding region of the previous frame.

6. The method defined in claim 5 wherein the substitute data for a region results in a smaller amount of data sent for that region than if all the data for the region is sent.

7. The method defined in claim 6 wherein the substitute data comprises data that is more compressible than data of the region.

8. The method defined in claim 7 wherein the substitute data is a solid color.

9. The method defined in claim 6 wherein the substitute data comprises data that is a smaller amount of data than data of the region.

10. The method defined in claim 9 wherein the substitute data comprises data that is a subset of data of the region.

11. The method defined in claim 1 further comprising sending information to the data sink indicative of which of the one or more regions has changed or has not changed.

12. The method defined in claim 1 wherein the one or more regions includes a first region of a left eye frame and a second region of a right eye frame, and wherein comparing a signature for one or more regions of a current frame of the image data to a signature of a corresponding region of one or more previous frames comprises comparing a signature for the first region with a signature of a corresponding region in a previous left eye frame and comparing a signature for the second region with a signature of a corresponding region in a previous right eye frame, in order to determine if a change has occurred; and further wherein sending the region to the data sink if comparing the signature results in determining that the signature of the region does not match a signature of a corresponding region of a previous frame available at the data sink comprises
sending the first region to the data sink if comparing the signature results in determining that the signature of the first region does not match the signature of the corresponding region of the previous left eye frame available at the data sink; and
sending the second region to the data sink if comparing the signature results in determining that the signature of the second region does not match the signature of the corresponding region of the previous right eye frame available at the data sink.

13. The method defined in claim 1 wherein the one or more regions includes interlaced regions with odd and even regions of the current frame, and further wherein comparing a signature for one or more regions of a current frame of the image data to a signature of a corresponding region of one or more previous frames comprises comparing a signature for an odd region with a signature of a corresponding odd region of the previous frame and comparing a signature for an even region with a signature of a corresponding even region of the previous frame, in order to determine if a change has occurred between the current frame and the previous frame; and further wherein sending the region to the data sink if comparing the signature results in determining that the signature of the region does not match a signature of a corresponding region of a previous frame available at the data sink comprises
sending the odd region to the data sink if comparing the signature results in determining that the signature of the odd region does not match a signature of the corresponding odd region of the previous frame available at the data sink; and
sending the even region to the data sink if comparing the signature results in determining that the signature of the even region does not match a signature of the corresponding even region of the previous frame available at the data sink.

14. The method defined in claim 1 further comprising grouping information regarding neighboring regions of the one or more regions to form a superset region.

15. The method defined in claim 1 wherein at least one of the one or more regions is a slice of a plurality of pixel lines of a frame.

16. The method defined in claim 15 wherein the slice is 8 lines.

17. The method defined in claim 1 wherein one region is a rectangle.

18. The method defined in claim 17 wherein the rectangle is an 8×8 square of pixels.

19. The method defined in claim 1 wherein the one or more regions comprise a single region consisting of an entire frame.

20. The method defined in claim 1 wherein each of the one or more regions comprises a plurality of components and the signature is based on less than all components in the plurality of components.

21. The method defined in claim 20 wherein the plurality of components include luma and chroma components or color components.

22. The method defined in claim 1 further comprising preventing transmission of the region if the signature of the region matches the signature of the corresponding region of the previous frame.

23. The method defined in claim 1 wherein comparing the signature results in determining that the signature of the region does not match a signature of the corresponding region of the previous frame available at the data sink if an acknowledgment has not been received from the data sink that the data sink had received the corresponding region of the previous frame.

24. The method defined in claim 1 further comprising using a portion of the transmission bandwidth to transfer extra data associated with another region of the one or more regions when signatures don't match, the extra data being transferred using bandwidth that would have been used to transfer the one or more regions had signatures matched.

25. The method defined in claim 24 wherein the transmission bandwidth is predetermined.

26. The method defined in claim 24 wherein the extra data comprises finer image data associated with the another region.

27. The method defined in claim 1 wherein pixel data of one region is split into coarse data and fine data, and further comprising comparing a first signature associated with the coarse data and a second signature associated with the fine data with signatures associated with coarse and fine data of a corresponding region of the previous frame to determine whether to transmit the region to the data sink.

28. The method defined in claim 1 further comprising generating the signature for the region without using all data of the region.

29. The method defined in claim 28 wherein generating the signature for the region without using all data of the region comprises applying a function to image data of the region in which least significant bits have been excluded.

30. The method defined in claim 1 further comprising sending the region to the data sink when the region has been designated prior to and irrespective of signature comparison to have its image data sent to the data sink.

31. The method defined in claim 30 wherein the frequency and amount parameters are set such that regions in a frame are transmitted irrespective of signature comparison to ensure that each region is periodically transmitted.

32. The method defined in claim 1 further comprising reducing power consumption of one or more image data source resources including one or more of a group consisting of a radio of the data source, a PHY of the data source, and an encoder of the data source, when the region is not transmitted to the data sink.

33. The method defined in claim 1 further comprising sending information indicative of whether or not the region is transmitted to the data sink.

34. The method defined in claim 33 wherein the information indicative of the region comprises one selected from a group consisting of: one or more region serial numbers and a per-region marker.

35. An apparatus for reducing an amount of image data that is provided by an image data source when providing frames of image data to a data sink, where each of the frames includes one or more regions, the apparatus comprising:
a memory to store one or more regions of a current frame;
a signature comparison logic coupled to the memory and operable to compare a signature for the one or more regions of the current frame of the image data to a signature of a corresponding region of one or more previous frames; and
a controller coupled to the memory and the signature comparison logic and operable to cause, for a region of the one or more regions, the region of the image data to be sent to the data sink if the signature comparison logic determines that the signature of the region does not match a signature of a corresponding region of a previous frame available at the data sink.

36. The apparatus defined in claim 35 wherein the signature comprises a checksum.

37. The apparatus defined in claim 36 wherein the checksum is a CRC.

38. The apparatus defined in claim 35 wherein the controller causes substitute data to be sent in place of the region if the signature of the region matches the signature of the corresponding region of the previous frame.

39. The apparatus defined in claim 38 wherein the substitute data for a region results in a smaller amount of data sent for that region than if all the data for the region is sent.

40. The apparatus defined in claim 39 wherein the substitute data comprises data that is more compressible than data of the region.

41. The apparatus defined in claim 40 wherein the substitute data is a solid color.

42. The apparatus defined in claim 39 wherein the substitute data comprises data that is a smaller amount of data than data of the region.

43. The apparatus defined in claim 42 wherein the substitute data comprises data that is a subset of data of the region.

44. The apparatus defined in claim 35 wherein the controller causes information to be sent to the data sink indicative of which of the one or more regions has changed or has not changed.

45. The apparatus defined in claim 35 wherein at least one of the one or more regions is a slice of a plurality of pixel lines of a frame.

46. The apparatus defined in claim 35 wherein the one region comprises a single region consisting of an entire frame.

47. The apparatus defined in claim 35 wherein each of the one or more regions comprises a plurality of components and the signature is based on less than all components in the plurality of components.

48. The apparatus defined in claim 47 wherein the plurality of components include luma and chroma components or color components.

49. The apparatus defined in claim 35 wherein the controller prevents transmission of the region if an acknowledgment had been received from the data sink that the data sink had received a corresponding region of the previous frame.

50. The apparatus defined in claim 35 further comprising signature generation logic to generate the signature for the region without using all data of the region.

51. The apparatus defined in claim 50 wherein the signature generation logic generates the signature for the region without using all data of the region by applying a function to image data of the region in which least significant bits have been excluded.

52. The apparatus defined in claim 35 wherein the controller sends the region to the data sink when the region has been designated prior to and irrespective of signature comparison to have its image data sent to the data sink.

53. The apparatus defined in claim 35 wherein the controller causes information indicative of the region to be sent to the data sink if the region is not transmitted, wherein the information indicative of the region comprises one selected from a group consisting of: one or more region serial numbers and a per-region marker.

54. An article of manufacture having one or more non-transitory computer readable storage media storing instructions which when executed by an image data source causes the image data source to perform a method when providing frames of image data to a data sink, where each of the frames includes one or more regions, the method comprising:
comparing a signature for one or more regions of a current frame of the image data to a signature of a corresponding region of one or more previous frames;
for a region of the one or more regions, sending the region to the data sink if comparing the signature results in determining that the signature of the region does not match a signature of a corresponding region of a previous frame available at the data sink.
